(19) United States
(12) Patent Application Publication
(10) Pub. No.: US 2021/0376650 A1
(43) Pub. Date: Dec. 2, 2021

(54) SELF-CHARGING AUXILIARY POWER SYSTEM FOR A VEHICLE

(71) Applicant: Harrison Hydra-Gen, Houston, TX (US)

(72) Inventors: Paul Newton, Houston, TX (US); Phillip DeCorte, Tomball, TX (US); Richard Otwell, Houston, TX (US); Lee McClanahan, Houston, TX (US)

(73) Assignee: Harrison Hydra-Gen, Houston, TX (US)

(21) Appl. No.: 17/334,594

(22) Filed: May 28, 2021

Related U.S. Application Data
(60) Provisional application No. 63/032,856, filed on Jun. 1, 2020.

(51) Int. Cl. H02J 7/14; F15B 1/26; F15B 15/20; H02J 7/00

(52) U.S. Cl. CPC H02J 7/1423; H02J 7/0048; F15B 15/20; F15B 1/26

(57) ABSTRACT

A self-charging auxiliary power system is configured to be mounted on a vehicle and includes a hydraulic generator and at least one battery. The battery is electrically coupled to and operable to be charged by the hydraulic generator. A cooling system is operable to cool hydraulic fluid that drives the hydraulic generator. A housing protects the at least one battery.

### CROSS-REFERENCE TO RELATED APPLICATION

This application claims priority to U.S. Provisional Application for Patent No. 63/032,856, filed on Jun. 1, 2020, the disclosure of which is incorporated herein by reference.

### TECHNICAL FIELD

This disclosure relates in general to a vehicle-mounted auxiliary power system, and, in particular, but not by way of limitation, to a system including an electro-chemical storage device and a hydraulically driven charging system for the electro-chemical storage device.

### BACKGROUND

It is known to couple a power take-off (PTO) to a transmission of a vehicle to allow the internal combustion engine of the vehicle to provide rotational motion and torque to drive auxiliary components. For example, if a hydraulic pump is coupled to a PTO, the hydraulic pump can be used to provide hydraulic fluid to an electrical generator or other hydraulic equipment. A power take off (PTO) drives a hydraulic pump, such as a variable displacement pump or a gear pump. The pump causes hydraulic fluid to flow through a hydraulic circuit. The hydraulic circuit provides pressurized hydraulic fluid to auxiliary equipment that may include a hydraulic generator.

Recreational vehicles and emergency vehicles, such as fire trucks, ambulances, and police cruisers rely on electrical power created by a hydraulic generator to operate auxiliary electrical equipment. Auxiliary electrical equipment includes, but is not limited to, HVAC equipment, interior lighting, exterior lighting, communications equipment, life-support systems, and the like. In a conventional hydraulic generator system, the vehicle engine runs, either at idle or under load powering the motion of the vehicle, to allow the electrical generator to be operational. Thus, the vehicle is consuming fuel, generating noise, and producing emissions associated with an internal combustion engine, such as a gas or diesel engine, in order to operate electrical equipment, either while being driven or idling at the scene of an emergency.

If the vehicle is not equipped with an electrical generator, the alternator of the vehicle when coupled with an inverter may supply the power to operate auxiliary electrical equipment. In either the case of power supplied by a hydraulic generator or an alternator, the vehicle is running.

Idle reduction systems are employed for a variety of reasons. Idle reduction systems use software, a processor (i.e. idle reduction controller), and other sensors to determine when the demand for engine power is low, for example when the vehicle is stopped at a red light, and shuts down the engine. When the demand for engine power returns, for example when the brake is released and/or accelerator is depressed to accelerate from the stop, the idle reduction senses the demand for engine power and actuates the ignition system of the engine. While the engine is not running, certain auxiliary electronic equipment, such as HVAC system, interior lighting, communications equipment, and the like are provided power by the electrical system of the vehicle or by an auxiliary power system.

Idle reduction systems on emergency vehicles function similarly, but the electrical system is expected to power auxiliary components for longer periods, for example at an accident scene, where first responders require access to lighting systems, communications systems, and even life-saving equipment. The auxiliary electrical system includes an electro-chemical storage device, such as one or more batteries. The battery includes one or more electrochemical cells in which a chemical reaction occurs that creates electrical energy. The chemical reaction consumes the resources of the battery, and therefore must be recharged to allow repeated use. Batteries are conventionally charged and recharged using shore power or the alternator of the vehicle.

### SUMMARY

A self-charging auxiliary power system is configured to be mounted on a vehicle and includes a hydraulic generator and at least one battery. The battery is electrically coupled to and operable to be charged by the hydraulic generator. A cooling system is operable to cool hydraulic fluid that drives the hydraulic generator. A housing protects the at least one battery.

According to an embodiment, the self-charging auxiliary power system may include a frame that is configured to be mounted on a vehicle. A hydraulic generator and at least one battery that may be supported by a frame. The battery is operable to be charged by the hydraulic generator. A cooling system is operable to cool the hydraulic generator and the at least one battery simultaneously, and a housing may be coupled to the frame and protects the hydraulic generator and the at least one battery.

Technical advantages of a self-charging auxiliary power system according to the teachings of the present disclosure include consolidated thermal management of heat generating components, such as the hydraulic generator and the battery system. Also, installation of the self-charging system on a vehicle, such as an emergency vehicle, is more efficient and simplified.

Further technical advantages include an auxiliary power system for a vehicle that can be charged with the transmission as the prime mover, either while the vehicle is idling or while the vehicle is being driven.

Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE FIGURES

A more complete understanding of the method and apparatus of the present disclosure may be acquired by reference to the following Detailed Description when taken in conjunction with the accompanying drawings wherein:

FIG. 1 is a perspective views of a self-charging auxiliary power system that uses the drivetrain as the prime mover for a hydraulically driven charging system according to the teachings of the present disclosure;

FIG. 2 is a perspective view of an alternate embodiment of a self-charging auxiliary power system that uses the drivetrain as the prime mover for a hydraulically driven charging system

FIG. 3 is a perspective view of certain components of the self-charging auxiliary power system shown in FIG. 1 with portions of the housing removed to show the internal components including the hydraulically driven charging system and the auxiliary power system;

FIG. 4 is a schematic drawing of a hydraulic circuit used to power a hydraulically driven charging system, such as a hydraulic generator, to enable charging of the self-charging auxiliary power system using the drivetrain as the prime power source according to the teachings of the present disclosure;

FIGS. 5A-5C are various views of interface panels of the self-charging auxiliary power system according to the teachings of the present disclosure; and

FIG. 6 is a view of an example display associated with the self-charging auxiliary power system according to the teachings of the present disclosure.

### DETAILED DESCRIPTION

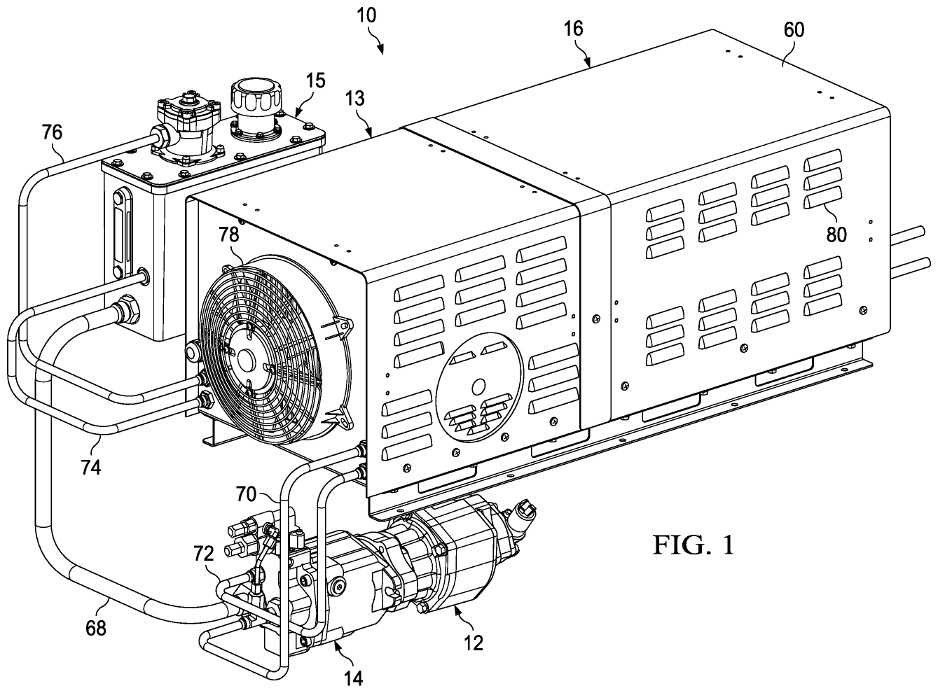

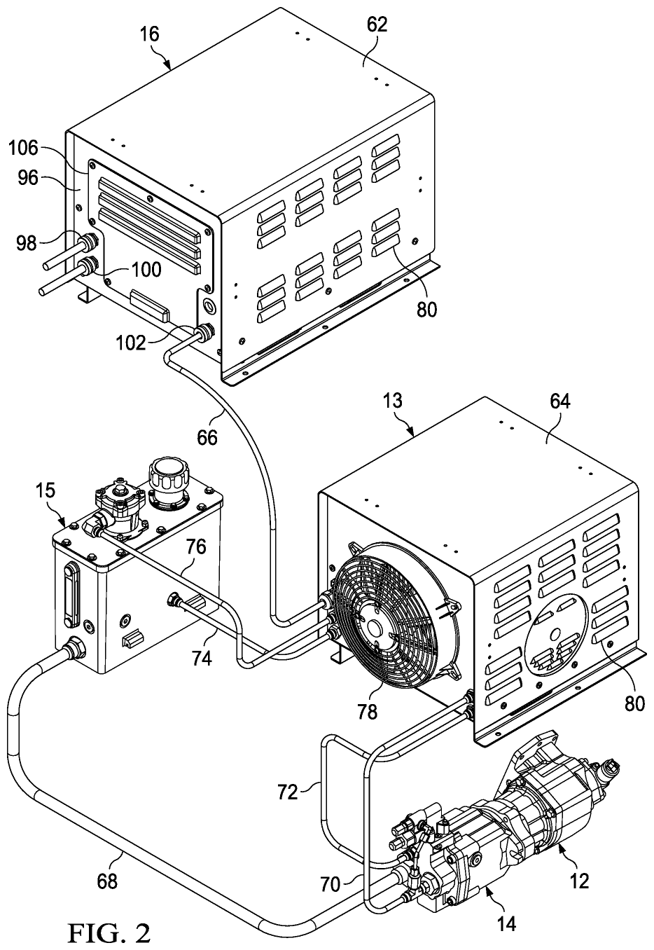

Reference is made to FIG. 1, which is a perspective view of a self-charging auxiliary power system 10 and associated components according to the teachings of the present disclosure. The self-charging auxiliary power system 10 includes a hydraulically driven charging system 13 and an auxiliary power system 16. The auxiliary power system 16 provides low voltage DC electrical power to certain electrical equipment. The hydraulically driven charging system 13 generates AC power that is used to charge the electro-chemical storage devices, for example batteries, of the auxiliary power system 16. The hydraulically driven charging system 13 and the auxiliary power system 16 may be contained in a housing 60 and provided as a self-contained unit, as shown in FIG. 1. Alternatively, the auxiliary power system 16 may be contained in a separate housing 62 from a housing 64 of the hydraulically driven charging system 13, as shown in FIG. 2. This embodiment may allow more flexibility in mounting the components on a vehicle because they can be mounted in separate locations and joined by an AC power cord 66.

A hydraulic pump 14 is in fluid communication with a hydraulic reservoir 15 via a suction conduit 68. The suction conduit 68 may be a flexible hose or a rigid pipe with sufficient volume to allow hydraulic fluid to be drawn from the reservoir 15 by the pump 14. The reservoir 15 may be equipped with a return filter and a filler-breather cap. The pump 14 may be a hydraulic piston pump operable to provide constant flow of hydraulic fluid under varying revolutions per minute of the engine of the vehicle.

The pump 14 supplies hydraulic fluid under pressure through a pressure hose 70 to the hydraulically driven charging system 13, and more specifically to a hydraulic generator 17. A pump case hose 72 allows the hydraulic fluid that is not pumped to the hydraulic generator 17 to return to the reservoir 15 through a case return hose 74. The hydraulic fluid that drives the hydraulic generator returns to the reservoir 15 through a return hose 76. A fan cage 78 is positioned to allow air to be drawn into the hydraulic generator housing 60 through a plurality of vents 80 in the sheet metal housing 60 by a fan. According to the embodiment shown in FIG. 2, the fan draws ambient air through the vents 80 in the housing 64 of the hydraulically driven charging system 13. The drawn air is cooled and the cooled air cools the circulating hydraulic fluid and certain components of the self-charging auxiliary power system 10.

The self-charging auxiliary power system 10 may be used with a processor and software of an automatic start/stop system. The automatic start/stop system uses software, a processor (i.e. idle reduction controller), and other sensors to determine when the battery has been depleted such that the source for the electrical components should be switched from power supplied by auxiliary power system 16 to the battery associated with the chassis of the vehicle. While the engine is not running, certain auxiliary electronic equipment, such as HVAC system, interior lighting, communications equipment, and the like are provided power by the self-charging auxiliary power system 10 or when the battery 20 is depleted the auxiliary electronic equipment are supplied with power from the 12 volt battery of the chassis of the vehicle.

The electro-chemical storage device may be embodied in one or more batteries. The electro-chemical storage device is a component of the auxiliary power system 16 that supplies low voltage DC electric power to operate auxiliary electrical equipment. The hydraulically driven charging system 13 facilitates charging of the battery or batteries (referred to herein as a battery) when a drivetrain of the vehicle is engaged. The hydraulically driven charging system 13 may be embodied in a hydraulic generator. Each of the components show in FIGS. 1 and 2 may be mounted to a vehicle, for example a chassis of a vehicle. The components are connected by hydraulic fluid conduits and electrical cables, as described in more detail below.

The self-charging auxiliary power system 10 for drivetrain driven charging according to the teachings of the present disclosure is coupled to other components of a vehicle-mounted hydraulic system. A power take off (“PTO”) 12 is rotated by the transmission of the vehicle, for example the transmission of any mobile vehicle, such as a recreational vehicle, an ambulance, fire truck, police cruiser, and the like. The transmission drives the power takeoff 12 which in turn drives the hydraulic pump 14. The power take off 12 is shown exploded from the pump 14. The power takeoff 12 is directly connected to the pump 14 to provide rotational motion to the pump 14. According to one embodiment, a male spline of the pump 14 is mated with a female spline fitting of the power take off 12. Alternatively, a drive line may run from the power take off 12 to operatively couple to the pump 14 using a keyed shaft.

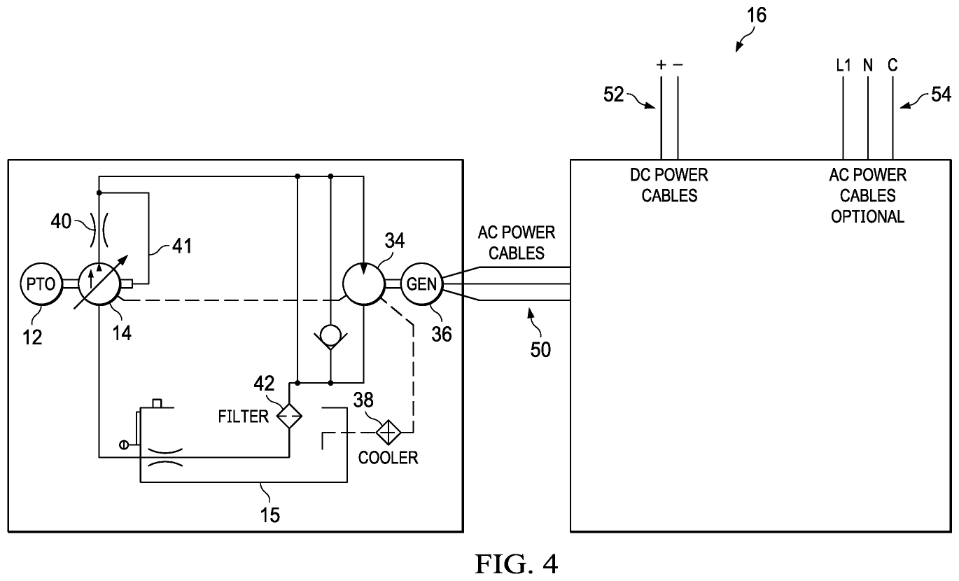

The rotational motion of the pump 14 draws hydraulic fluid from a reservoir 15 and circulates the hydraulic fluid through a hydraulic circuit. The hydraulic circuit includes hoses, valves, orifices, load sense lines, filters, and the like that facilitate controlled flow of the hydraulic fluid at desired pressures and volumes. The hydraulic pump 14 may be any suitable hydraulic pump, for example a variable displacement pump or a gear pump. A schematic of an example hydraulic circuit according to the teachings of the present disclosure is shown in FIG. 4.

According to certain embodiments, the hydraulic circuit may provide hydraulic fluid to power a hydraulically driven charging system 13 to charge the energy storage system (i.e. battery or batteries) of the auxiliary power system 16 using the drivetrain of the vehicle. Thus, the electro-chemical storage device(s) of the auxiliary power system 16 is charged by the drivetrain of the vehicle which powers the power take off 12, which drives the hydraulic pump 14, which provides hydraulic fluid under pressure through a hydraulic circuit to a hydraulic generator 17. According to an embodiment, the hydraulic generator 17 is supported by a frame 18 and contained in the same housing 60 as the auxiliary power system 16. Thus, the energy storage device(s) can be recharged while the vehicle is running, either at idle or while driving the vehicle. In other words, the hydraulic generator 17 contained in the housing 60 with the auxiliary power system 16 may be a dedicated charger of the batteries, or other energy storage device(s), of the auxiliary power system 16.

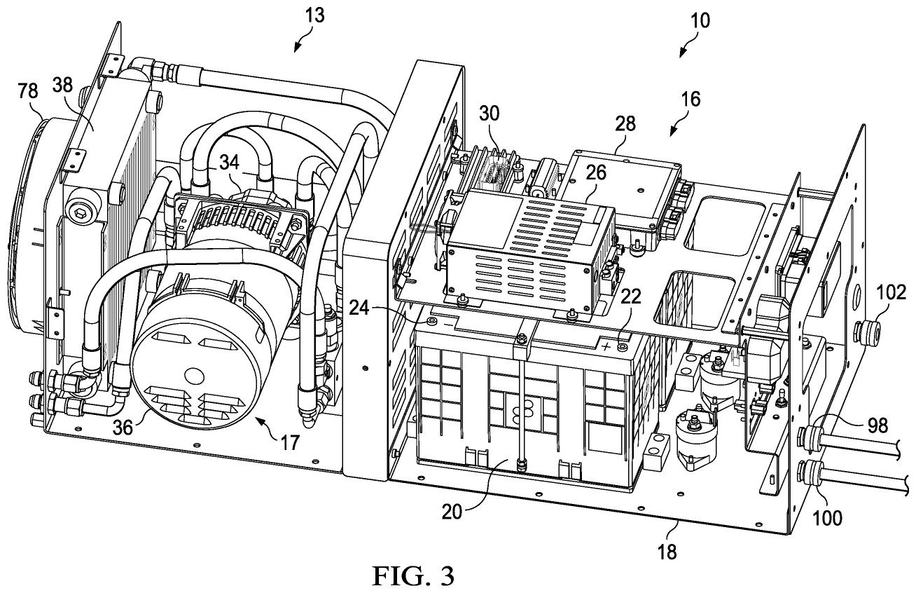

Reference is made to FIG. 3, which shows a perspective view of the self-charging auxiliary power system 10 with the housing 60 removed to show the internal components. The frame 18 of the self-charging auxiliary power system 10 may be formed of sheet-metal or composite and/or polymeric materials. According to one embodiment, the frame 18 is formed of steel, of a suitable thickness. The housings 60, 62, and 64 shown in FIGS. 1 and 2, may also be formed of sheet metal, for example steel. The frame 18 and the housings 60, 62, and 64 provide a sturdy, protective enclosure and mounting surfaces for the components of the self-charging auxiliary power system 10, as explained in further detail below.

At least one electro-chemical storage device (i.e. battery) 20 is supported by the frame 18. According to certain embodiments, two or more batteries 20 are secured to the frame 18. The batteries may be any suitable device that includes at least one electrochemical cell to store electrical energy. The battery is chargeable by electric power input using the electrochemical effect. For example, the batteries may be lithium iron phosphate (LiFePO₄) batteries. The batteries 20 include a positive terminal 22 and a negative terminal 24. The batteries 20 provide the appropriate volts of direct current as an output. According to one embodiment, the batteries 20 may provide approximately 12 V DC power output. Other power output of the batteries 20 are contemplated by this disclosure. For example, the batteries 20 may provide DC output of 12, 24, 36, 48, or 60 volts DC depending on a number of electrochemical cells that are electrically coupled in series. Typically, batteries providing power to auxiliary electrical equipment on a vehicle are of relatively low voltage.

A battery charger 26 is also secured to the frame 18. The battery charger 26 facilitates multiple ways of charging the batteries 20. For example, the battery charger 26 may be coupled to a conventional AC outlet when the vehicle is parked and not in use. This may be referred to as charging the batteries 20 with shore power. The batteries 20 may also be charged through the alternator of the vehicle. In this manner, the battery 20 may be charged while the vehicle is idling or moving. However, charging the battery with the alternator diverts power that may be used for other equipment to charge the battery and in certain instances may be less desirable.

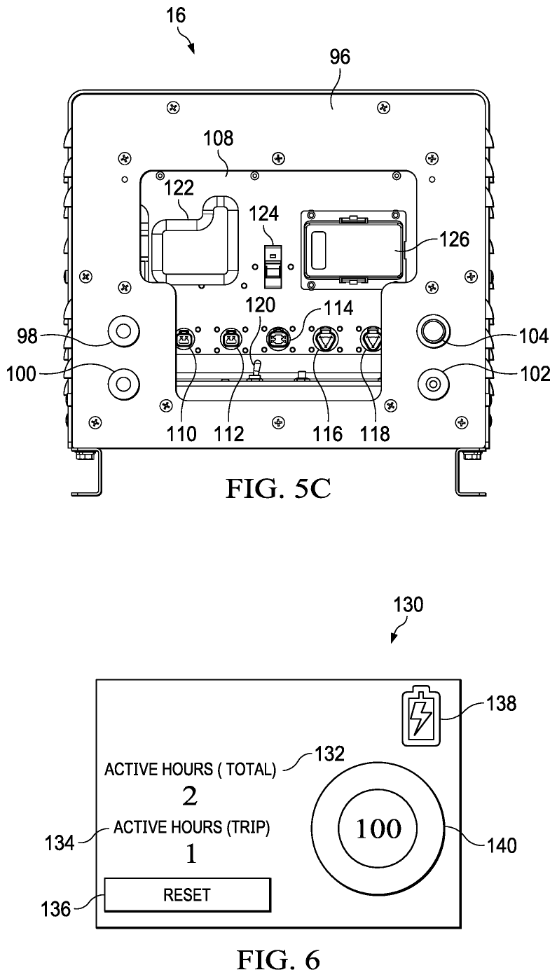

A battery monitoring system 28 is also secured to the frame 18. The battery monitoring system monitors the capacity of the batteries and the depletion of the batteries 20. This information is displayed to an operator through a display device. An example of a display is shown and described with respect to FIG. 6.

A control module 30 may be secured to the frame 18. The control module 30 receives information from the battery monitoring system 28 to monitor and control the batteries and the overall system. According to certain embodiments, the auxiliary power system 16 may also include an inverter. The inverter allows the DC power of the battery to be converted to AC power. The auxiliary power system 16 includes appropriate electrical connections to allow the system to provide the appropriate electrical power to auxiliary equipment of the vehicle when the drivetrain of the vehicle is disconnected because the vehicle is not running. In other words, the vehicle is switched off and is not idling. Thus, idling of a mobile vehicle at an emergency scene is mitigated and reduced and the associated environmental effects are also minimized.

A hydraulically driven charging system 13 is also secured to the frame 18. Thus, the auxiliary power system 16 including the lithium iron phosphate batteries 20 and the hydraulically driven charging system 13 is self-contained in a single frame 18 and a single housing 60. The frame 18 and housing 60 may be mounted to an emergency vehicle and fluidly coupled to a hydraulic circuit associated with the emergency vehicle.

The hydraulically driven charging system 13 includes a hydraulic motor portion 34 and an electricity generating portion 36. The electricity generating portion 36 is also referred to as an alternator. According to an embodiment, the alternator 36 may be an AC brushless revolving field alternator operable to provide regulated 120/240 Volts AC. The alternator 36 may operate at approximately 3600 rpm or at 1800 rpm for 60 Hertz operation. The hydraulic motor portion 34 receives pressurized hydraulic fluid through the hydraulic circuit that is moved through the hydraulic circuit by the hydraulic pump 14. According to an embodiment, the hydraulic motor portion 34 may be a gear motor with an external case drain and a displacement of approximately 8-cubic centimeters. Other sizes and hydraulic motor configurations, such as a piston motor or a vane motor may be used in lieu of the gear motor.

The hydraulic fluid may be cooled by a hydraulic fluid cooler 38. The hydraulic fluid cooler may be a heat exchanger operating as an air over hydraulic cooler. A fan pulls air across the cooler 38. The hydraulic fluid turns the hydraulic motor portion 34. The rotational motion of the motor 34 operates the electricity generating portion 36, and the electricity generating portion 36 produces AC power to the battery charger 26. The electrical connection from the alternator 36 to the charging input of the auxiliary power system 16 may be internal to the housing, or as shown in FIG. 2, the electrical connection may be made with the external AC power cord 66. In this manner, the batteries 20 may be charged by the vehicle drivetrain that powers the power take off 12. The batteries 20 may be charged while the vehicle is in motion or stationary an idling and the hydraulic fluid is pumping through the hydraulic circuit. The charge delivered to the batteries 20 is facilitated without employing the vehicle's alternator. The hydraulic generator 17 may be a 3.0 kW hydraulically driven AC generator that provides 120 V of AC power to the charger 26. Other suitable power outputs of the hydraulically driven charging system 13, and more specifically the generator 17, are contemplated by this disclosure.

FIG. 4 is a schematic diagram of a hydraulic circuit providing the hydraulic fluid to charge the batteries 20 of the auxiliary power system 16, which may be used to reduce vehicle idling. The power take off 12 receives rotational motion from the engine of the vehicle. The power takeoff 12 is connected to the hydraulic pump 14. A hose or other suitable conduit draws hydraulic fluid from the reservoir 15. The pump 14 pumps the hydraulic fluid to the hydraulic motor portion 34 of the hydraulic generator 17.

A load sensing line 41 may be used in connection with an orifice 40 to automatically sense a load and adjust the flow at the pump 14 to maintain a generally constant pressure differential across the orifice 40. The load sensing feature of the hydraulic circuit is employed to automatically regulate the flow from the hydraulic pump 14 and compensate for fluctuations in the rotational speed of the power take off 12. The load sense line 41 that is fluidly coupled to the variable displacement pump 14 causes adjustment of the flow delivered by the pump 14 in order to maintain a constant pressure drop across the orifice 40 disposed in the hydraulic circuit. In this manner, variable input provided by the PTO due to fluctuations in revolutions per minute (RPM) of an engine that is not idling, are compensated for by the variable displacement pump 14 and constant hydraulic fluid flow is provided to the hydraulic motor portion 34 despite fluctuations in vehicle RPM. Thus, by using a variable displacement pump 14, the electrical generator portion 36 may be operated to provide a generally constant electrical charge to charge the battery 20 while the vehicle is being driven.

The hydraulic fluid turns the hydraulic motor portion 34. The hydraulic motor portion 34 is connected to the electricity generating portion 36 (i.e. alternator) and the motion of the motor portion 34 creates the electrical current outputted from the electricity generating portion 36. The hydraulic fluid continues to flow from the hydraulic motor portion 34 through a filter 42 and back to the hydraulic pump 14. Also, the hydraulic fluid may flow through a cooler 38 and back to the reservoir 15. The filter 42 may capture impurities in the hydraulic fluid and clean the hydraulic fluid to ensure that none of the hydraulic equipment is damaged as the hydraulic fluid is circulated through the circuit.

The electrical generator portion 36 generates AC power that is communicated through AC power cables 50 to the auxiliary power system 16. Alternatively, the AC power may be communicated through the AC power cord 66. More specifically, the AC power cables 50 provide AC current to the battery charger 26, which is secured to the frame 18. The hydraulic motor portion 34, the electricity generating portion 36, and the auxiliary power system 16 may be contained in a single housing that includes the frame 18. The housing protects the components of the system from the environment. The housing also allows the auxiliary power system 16 and the hydraulic generator 17 to the transported and installed in a vehicle. The auxiliary power system 16 provides DC power output through the DC power cables 52 coupled to the terminals 22, 24 of the batteries 20. According to an alternate embodiment, the auxiliary power system 16 may also provide AC power through AC power cables 54, in addition to, or as a substitute for the DC power, depending on the particular needs of the electrical equipment powered by the auxiliary power system 16.

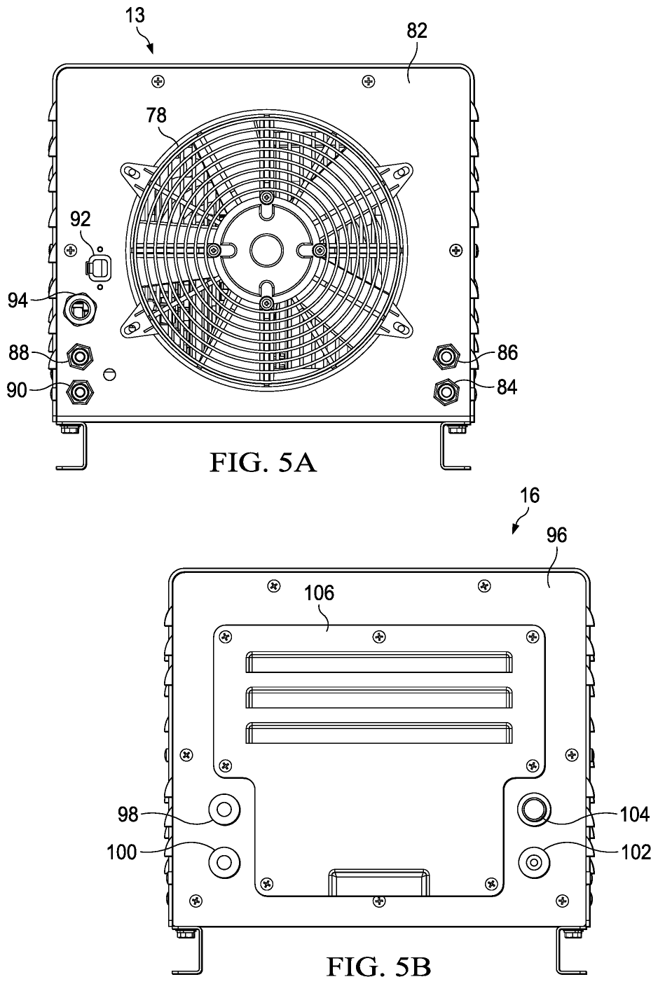

Reference is made to FIG. 5A, which is front, elevation view of the hydraulically driven charging system 13 illustrating the hydraulic and electrical connections providing input to and output from the system 13. A face 82 of the hydraulically driven charging system 13 supports the fan cage 78. The face 82 also includes hydraulic fittings that are configured to couple to the hydraulic hoses described herein. The fittings allow a fluid-tight connection to allow the hydraulic fluid to circulate through the hydraulic circuit under pressure. The face 82 includes a pump case-in fitting 84 that couples to the pump case hose 72. A pressure-in fitting 86 couples to the pressure hose 70. The connection between the pressure-in fitting 86 and the pressure hose 70 facilitates flow of hydraulic fluid under pressure from the pump 14 to the hydraulic generator 17.

The face 82 also includes a return out fitting 88. The return out fitting 88 couples to the return hose 76, which couples to the reservoir 15. More specifically, the return out hose 76 couples to a hydraulic fluid filter 42 (see FIG. 4) associated with the reservoir 15 to ensure that hydraulic fluid that has circulated through the hydraulic generator is filtered before returning to the reservoir 15 for recirculation. The face 82 also includes a case-out fitting 90. The case-out fitting 90 couples to the case return hose 74 to allow fluid that drains from the pump case to flow back to the reservoir 15 for recirculation. Each of the hydraulic fittings may be a Joint Industry Council (JIC) fitting commonly used in hydraulic fluid circuits.

The face 82 also includes electrical connections. The electrical connectors may be Deutsch-type connectors. The face 82 may include an input power connector 92. The input power connector 92 connects with an electrical cable that is connected to the vehicle's battery. According to an embodiment, power from the vehicle's battery powers the fan of the hydraulically driven charging system 13. According to certain embodiments, such as the separate charger 13 and auxiliary power source 16 embodiment shown in FIG. 2, a power output connector 94 is included on the face 82. As shown in FIG. 2, the power output connector 94 may connect to an electrical cable 66 that connects to a 120 V AC input on the auxiliary power source 16 to facilitate charging the batteries using the hydraulic generator. According to other embodiments, the power output connector 94 may be omitted and the electrical connection between the hydraulically driven charging system 13 and the auxiliary power system 16 may be provided by cabling within the housing 60.

FIG. 5B illustrates a face 96 of the auxiliary power system 16, which may be disposed at a rear of the system 10 and is labeled herein a rear face although it may not be disposed at a rear of a particular housing, as for example shown in FIG. 2. The rear face 96 of the auxiliary power system 16 supports certain electrical connectors. The rear face 96 includes a DC positive load output connector 98. The load output connector 98 connects with an electrical cord that supplies power from the auxiliary power system 16 to the auxiliary electrical equipment, such as HVAC equipment, interior lighting, exterior lighting, communications equipment, life-support systems, and the like. A DC negative load connector 100 connects to an electrical cable that is connected to chassis ground. The rear face 96 also includes a charger connector 102. The charger connector 102 connects to an electrical cable output (for example AC electrical cord 66) from the hydraulically driven charger 13 to allow the batteries to be charged by the AC power generated by the hydraulic generator 17. Alternatively, the charger connector 102 may be electrically coupled to the alternator of the vehicle using an inverter or to shore power for the purposes of charging the batteries 20. The rear face 96 may include an additional connector 104. In certain embodiments, the connector 104 may be electrically coupled to an inverter associated with the auxiliary power system 16 to allow the auxiliary power system to deliver 120 Volts AC power output to certain electrical equipment that may be on-board the vehicle.

The rear face 96 also supports a removable panel 106. FIG. 5C shows the auxiliary power system 16 with the panel 106 removed. According to one embodiment, a vehicle connection interface panel 108 includes certain connectors to receive data or other communications from systems of the vehicle and to provide data output signals from the auxiliary power system 16 to external devices, such as a display or other indicator or control system that receives system status information. The connectors may be Deutsch connectors in either two-pin, three-pin, or four-pin types. A batteries available connector 110 provides an output signal from the auxiliary power system 16 indicating that internal system checks have been completed and passed and the batteries are available to provide DC power to auxiliary electrical equipment. A system-on connector 112 facilitates receipt of an input signal from the vehicle indicating that the auxiliary power system 16 will be on and operational. A chassis connector 116 is operable to receive or transmit with a controller area network node associated with the chassis of the vehicle. Similarly, an engine connector 118 is operable to receive data or other signals from a node of the vehicle's controller area network node associated with the engine of the vehicle. According to alternate embodiments, the chassis connector 116 and/or the engine connector 118 may be omitted. According to embodiments, the vehicle connection interface panel 108 supports battery fuses 122, circuit fuses and relays 126, and a battery charger circuit breaker 124.

The system 13 also includes a power switch 120. In normal operation, the power switch is switched to on. If power disconnection is required, for example to perform maintenance on the system 10, the power switch 120 is switched to off.

A display connector 114 facilitates a 4 wire cable connection with a display to provide indications of the state and functioning of the auxiliary power source 16. FIG. 6 shows a screen shot of a display 130 according to the teachings of the present disclosure. The display 130 includes fields to provide graphic and/or alphanumeric indications of battery function and status of the auxiliary power system 16. For example, the display 130 may include an active hour counter field 132, which shows the time period for which the system 10 has been active since the system was last rebooted. The display 130 may also include a trip counter field 134 and a trip reset button 136. The trip counter field 134 may display time in units, for example minutes, that the battery has been operating. According to certain embodiments, the auxiliary power system 16 may supply approximately 220 amp hours of power on a full battery charge. The display 130 may also include a charging indicator 138 that graphically and/or alphanumerically shows when the batteries are receiving charge from either the hydraulic generator 17, a shore power source, or the vehicle's alternator. The display 130 may also include a combined graphic and alphanumeric indicator 140 of the remaining charge of the batteries. The remaining charge indicator 140 may change colors as the percentage of charge diminishes to provide a warning to the user of the remaining battery power available.

The system also includes electrical connectors, fuses, power cables, and the like as is known in the art.

Employing the self-charging auxiliary power system 10 for drivetrain charging reduces fuel consumption, reduces diesel particulate filter (“DPF”) regeneration, and extends the life of the chassis of the vehicle.

The battery may supply 275 Amp-hours or more of power as needed. According to other embodiments, other battery outputs are contemplated by the present disclosure.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below,” “top” and “bottom” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A self-charging auxiliary power system, comprising:
a frame configured to be mounted on a vehicle;
a hydraulic generator mounted to the vehicle;
at least one battery supported by the frame, the battery being electrically coupled to be charged by the hydraulic generator;
a cooling system operable to cool hydraulic fluid that drives the hydraulic generator; and
a housing coupled to the frame and protecting the at least one battery.

2. The self-charging auxiliary power system of claim 1 wherein the hydraulic generator is supported by the frame.

3. The self-charging auxiliary power system of claim 2 wherein the cooling system comprises a fan operable to cool the at least one battery.

4. The self-charging auxiliary power system of claim 1 further comprising a battery charger electrically coupled to the hydraulic generator and the at least one battery.

5. The self-charging auxiliary power system of claim 1 further comprising a battery monitoring system operable to provide battery charge data for the at least one battery.

6. The self-charging auxiliary power system of claim 5 further comprising a control module in communication with the battery monitoring system.

7. A vehicle-mounted hydraulic system, comprising:
a hydraulic pump operatively coupled to a power take off of a vehicle;
a reservoir containing hydraulic fluid and being fluidly coupled to the hydraulic pump; and
a self-charging auxiliary power system, comprising:
a hydraulic generator fluidly coupled to the hydraulic pump;
at least one battery electrically coupled to the hydraulic generator, the at least one battery configured to be charged by the hydraulic generator; and
a cooling system operable to cool the hydraulic fluid.

8. The vehicle mounted hydraulic system of claim 7 further comprising a frame and wherein the hydraulic generator and the at least one battery are supported by the frame.

9. The vehicle mounted hydraulic system of claim 8 wherein the cooling system is operable to cool the hydraulic fluid associated with the hydraulic generator simultaneously with cooling the at least one battery.

10. The vehicle mounted hydraulic system of claim 7 further comprising a first frame supporting the hydraulic generator and a second frame supporting the at least one battery, wherein the first frame is separate from the second frame.

11. The vehicle mounted hydraulic system of claim 7 further comprising a battery charger electrically coupled to the hydraulic generator and the at least one battery.

12. The vehicle mounted hydraulic system of claim 7 further comprising a battery monitoring system operable to provide battery charge data for the at least one battery.

13. The vehicle mounted hydraulic system of claim 7 further comprising a control module in communication with the battery monitoring system.

14. The vehicle mounted hydraulic system of claim 7 wherein the hydraulic generator 17 is operable to deliver 3.0 kW of AC power.

15. The vehicle mounted hydraulic system of claim 7 wherein the hydraulic generator provides 120 volts of AC power.

16. A vehicle mounted auxiliary power system, comprising:
a hydraulic pump operatively coupled to a power take off of a vehicle;
a reservoir containing hydraulic fluid and being fluidly coupled to the hydraulic pump; and
a self-charging auxiliary power system, comprising:
a hydraulic generator fluidly coupled to the hydraulic pump;
at least one battery electrically coupled to the hydraulic generator, the at least one battery configured to be charged by the hydraulic generator;
a charger connector operable to be electrically coupled to an alternator of the vehicle via an inverter and operable to be electrically coupled to shore power to charge the at least one battery; and
a cooling system operable to cool the hydraulic fluid.

17. The vehicle mounted auxiliary power system of claim 16 further comprising a frame and wherein the hydraulic generator and the at least one battery are supported by the frame.

18. The vehicle mounted auxiliary power system of claim 17 wherein the cooling system comprises a fan and is operable to cool the hydraulic fluid simultaneously with cooling the at least one battery.

19. The vehicle mounted auxiliary power system of claim 16 further comprising a first frame supporting the hydraulic generator and a second frame supporting the at least one battery, wherein the first frame is separate from the second frame.

20. The vehicle mounted auxiliary power system of claim 16 further comprising a display configured to indicate a remaining charge of the at least one battery.
